(19) United States
(12) Patent Application Publication
(10) Pub. No.: US 2016/0108183 A1
(43) Pub. Date: Apr. 21, 2016

(54) METHOD FOR CONVERSION OF DRY NANOMATERIALS INTO LIQUID NANO-AGENTS FOR FABRICATION OF POLYMER NANOCOMPOSITES AND FIBER REINFORCED COMPOSITES

(71) Applicant: Washington State University, Pullman, WA (US)

(72) Inventors: Wie-Hong Zhong, Pullman, WA (US); Bin Li, Wichita, KS (US); Brooks Lively, Dublin, CA (US)

(21) Appl. No.: 14/919,235

(22) Filed: Oct. 21, 2015

Related U.S. Application Data
(60) Provisional application No. 62/066,864, filed on Oct. 21, 2014.

(51) Int. Cl. C08J 3/205; C08K 9/00; C08K 7/06

(52) U.S. Cl. CPC C08J 3/2053; C08K 7/06; C08K 9/00; C08J 2379/08; C08J 2371/10; C08J 2381/04; C08J 2381/06; C08J 2369/00; C08J 2365/00; C08J 2379/02

(57) ABSTRACT

Unique methods for the efficient and beneficial use of converting dry nanomaterials such as dry carbon particles into liquid nano-agents are disclosed herein. The methods provide for fabrication of polymer and fiber reinforced composites, such as fiber-reinforced resins having such introduced nanomaterials to enable an increased dispersion and other beneficial properties.

### CROSS-REFERENCE TO RELATED APPLICATIONS

This application claims the benefit of U.S. Provisional Patent Application No. 62/066,864, filed Oct. 21, 2014, the complete contents of which are herein incorporated by reference.

### BACKGROUND OF THE INVENTION

1. Field of the Invention

The present embodiments herein generally relate to the field of polymer materials, and more specifically to converting dry nanomaterials into liquid nano-agents for fabrication of polymer nanocomposites and fiber reinforced composites.

2. Discussion of the Related Art

By applying nanotechnology, many properties of polymers have shown improvement, such as, mechanical properties (strength, modulus and toughness), triblogical properties (wear, friction, hardness, etc.), and physical properties (optical, conductive, damping, magnetic and dielectric, etc). However, typically dry nanomaterials (nanoparticles, nanopowders, nanofibers, nanotubes, nanowires) are added into polymers directly as nano-fillers. As for master-batch methods for reinforcing thermoplastics, dry nanomaterials are also mixed with polymers.

Accordingly, for manufacturing fiber reinforced polymer (FRP) composites, challenging issues for obtaining high performance nano-modified polymers, i.e. nanocomposites related to successfully transferring the extraordinary properties of nano-fillers to the polymer matrices are: 1) dispersion of nano-fillers, 2) interaction of nano-fillers/polymer matrices, 3) health concern on operators' inhaling of dry nano-fillers associated with the processing of volume production, and 4) quality issues for nanocomposite parts critical for industry products and confident implementation of the products e.g. consistent and uniform quality across parts.

Challenging issues for fabricating fiber reinforced polymer (FRP) with incorporated nano-modified polymers, are 1) increased viscosity with addition of dry nano-fillers that will lead to high pressure/extra energy for making FRP composite parts, 2) filtering effects of the nano-filler agglomerates during the infusion of nano-modified resins in the fiber fabrics; 3) unstable quality of the FRP composite parts: uncontrollable voids and/or defects can be formed due to the non-uniform dispersion of nano-fillers in the resins.

Thus, a need exists in the industry for novel polymeric methods that can provide to manufacturers either: (a) a source of nanoparticles which is incorporated into a highly concentrated “master batch” polymer which can then be diluted later in the production process or (b) a source of nanoparticles which can be fed directly into a polymer system without subsequent co-extrusion to dilute downstream. The novel embodiments herein are directed to such a need.

### SUMMARY OF THE INVENTION

This invention yields well controlled uniform dispersion and stable quality nanocomposite products, and it is safer and more suitable for industry because production of the nanocomposite parts avoids exposure of operators to the risk of nanoparticle inhalation. Moreover, very small amounts of solvent are needed to make the polymer nanocomposite products, which can be easily prepared by a company lab or supplier.

It is to be noted that dispersion is a beneficial factor addressed herein for properties of the resultant polymer nanocomposites, because dispersion impacts both fundamental mechanical properties and fundamental physical properties. At the same time, proper surface modification can improve dispersion of the materials herein so as to strengthen interfacial bonding and impart new functionalities to the resultant nanocomposites. Thus, manufacturing nanocomposite products with well controlled uniform dispersion in industry is challenging in the field and is addressed herein.

It is to be appreciated that owing to extremely high surface energy of nanoparticles, nanomaterials tend to naturally agglomerate/entangle/aggregate, which inhibits fabrication of polymer nanocomposites. For fibrillar nanoparticles, the strong entanglement further prevents them from evenly dispersing in a polymer matrix. The strong tendency of nano-scale additives due to the huge surface attraction is overcome by the teachings herein so as to capitalize on the benefits of large surface-to-volume-based enhancements. Accordingly, as part of the methodologies utilized herein so as to aid in dispersing nano-fillers, include strong melt shear, high intensity ultrasonic (i.e., sonication) treatment and covalent chemical treatment of the surface of nano-fillers.

Another factor that the present invention addresses is the interaction between the nano-fillers (nanomaterials) and polymers. In particular, purified, oxidized, and functionalized nano-fillers are used herein to improve the interaction with thermoplastic polymers, the result of which significantly improves mechanical and physical properties for nanocomposites, as disclosed herein. Thus, external loads (mechanical, electrical, or thermal) are more effectively and efficiently transferred to the nano-fillers.

The embodiments herein also address health and environmental concerns that include inhaling of dry nano-fillers by operators during volume production in industry by using methods that can be utilized in well protected facilities and that result in low production rates and high capital investments. The resultant products herein also provide for consistent quality products because the methods used are controllable within an affordable capability.

The present embodiments herein are also directed to addressing the fabrication of the fiber reinforced polymers (FRP) with the incorporated nano-materials disclosed herein. A desired aspect for the materials herein is an increase in viscosity, which normally takes extra energy and this increases costs in providing the high pressure for the resin to flow inside fabrics for making FRP composites. The present embodiments address this issue by providing resin infusion methods (i.e., provides fabricators) to enable an affordable means of manufacturing large composite structures. The composite is then cured and demolded. The present embodiments herein also enable durable composite structures that avoid dry spots and void formation in the final assembly by thorough flow of the resins. Accordingly, the embodiments herein can enable as an example, easy resin flow and good fiber wetting for the successful fabrication of a resin infusion composite part, both of which rely on low resin viscosity as a necessary processing attribute.

The embodiments herein also address the filtering effect caused by the strong tendency of nano-filler aggregations to collect in micro-pores within the fiber tows leading up to complete blockage and resin starvation in many cases. Aggregations of carbon nano-fillers can have detrimental effects on part quality. Since these processes rely on resin flowing through the micro and macro-pores of complex and most commonly woven fiber preforms, it is often compared to fluid flow through a filter. This filtering effect results in the effective addition of nano-additives with good mixing in the polymer resin and proper resin infusion process setup. Less agglomerate of nano-fillers, low nano-loadings and low viscosity of the nano-modified resins are also utilized herein to reduce or avoid the filtering effect.

Lastly, unstable or uncontrollable quality of FRP composites with nanomaterials will prevent the materials from real application in industry. For any industry product, quality must be controllable. For successful commercialization of FRP with nano-modified resins, consistent and reliable performance of the final nano-modified product is provided. However, the quality of nano-modified FRP is highly dependent on the dispersion of the nano-fillers inside the matrix of the FRP and it is very challenging to control the dispersion level of dry nano-fillers in a polymer matrix material during the volume production of the FRP composites. However, the stable quality can be controlled through the present embodiments herein, i.e. to pre-disperse nano-fillers uniformly in a solution with a solvent that is compatible to the polymer resin first, and then adding the nano-solution into the resin to form the nano-modified resin as the matrix for making FRP.

It is to be appreciated that the present example embodiments herein are thus directed to a method for uniformly dispersing a nanomaterial within a polymer, the method of which includes: adding a nano-filler to a solvent; subjecting the nano-filler in the presence of the solvent to sonication so as to provide for a liquid nano-agent; and adding the liquid nano-agent with a polymeric material to produce a nano-modified polymer nanocomposite or a fiber reinforced composite.

### BRIEF DESCRIPTION OF THE DRAWINGS

FIG. 1A shows an image of raw nano-fillers in an undesirable entangled and agglomerated state.

FIG. 1B shows an image of the Liquid nano-agent (LNA) having uniform dispersed nano-fillers via the methods herein.

FIG. 2 shows cup stacked CNFs interacting with the BGE surface molecules via hydrogen bonding interactions.

### DETAILED DESCRIPTION

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. It is to be noted that as used herein, the term “adjacent” does not require immediate adjacency. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

In addition, unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

### General Description

Embodiments of a system and methods disclosed herein are generally directed to nanocomposites with substantially improved mechanical properties, static dissipation and acoustic damping; as well as functionalities to satisfy a variety of applications including aerospace (next generation airplanes, new space craft etc.), renewable energy structures (windmill, etc.) and ground transportation (a new national railroad network plan has been proposed by the Government) as well as in construction, sporting goods, medical appliances, and electronics. In particular, the present embodiments enable such applications via the control of the dispersion and other beneficial properties using, for example, surface modification of the nanomaterials (e.g., nanoparticles, nanopowders, nanofibers, nanotubes, graphene nanoparticles, and/or nanowires) disposed in the polymer matrix.

### Specific Description

It is to be noted that the liquid nanoagent (LNA) is often fabricated by cleaving the nano-filler (e.g., carbon nanofibers, carbon nanotubes, graphene nanoparticles, etc.) by a digital sonifier under a solvent. Exemplary solvents include, but are not limited to, one or more of the following: Dimethyl sulfoxide (DMSO), o-dichlorobenzene (ODCB), tetrahydrofuran (THF), N,N-dimethylformamide (DMF), methanol, N-methylpyrrolidone (NMP), acetone, methyl ethyl ketone (MEK), dichloromethane, toluene, N,N-dimethylacetamide (DMAc), Dichloromethane (DCM) and the preferred solvent butyl glycidyl ether (BGE). Thus, the choice of solvent is dictated by the size of the nanoparticles and/or functional groups with the benefits being: (1) safer handling of nanoparticles in industrial environments nanopowders are inherently difficult to control and health consequences of exposure to nano-materials, (2) reduction of solvent use in production facilities, (3) easier incorporation into a “master batch” polymer or multi-polymer system for later downstream co-extrusion into a lower concentration final product, (4) much better (vs. state of the art) incorporation into a final extrusion product in cases where the highly concentrated solution can be added directly, (5) better dispersion/distribution of the nanoparticles into the polymer system, (6) lower capital costs for production facilities, and (7) the ability to mix nanoparticles into polymers that would otherwise be difficult or impossible due to functional groups on the nanoparticles interfering with the mixing process—in this case, the solvent may act as a complexing agent to provide better chemical integration with the polymer system.

The aforementioned sonifier is an instrument technique that uses sonication. In particular, the technique uses sound waves (e.g., Ultrasound) to provide high energy to break down the carbon material agglomerates. Thus, at desired power levels, a user of the present embodiment(s) utilizes sound as a means that leads to the disentanglement and uniform dispersion of the nanomaterials. Specifically, the carbon nano-materials in the presence of a solvent and when subjected to sonication enables ease of dispersion because the combination results in shortened lengths of the carbon nanomaterials. Therefore, for the embodiments herein, sonication is a desired and beneficial step in the pre-treatment of the carbon nanomaterials and solution processing of resultant polymer nanocomposites. In some embodiments, other additives can be included to enhance the resultant material's properties. Example additives can include, but are not limited to, plasticizors, reinforcers including other nanoscale or microscale fillers, and UV stabilizers.

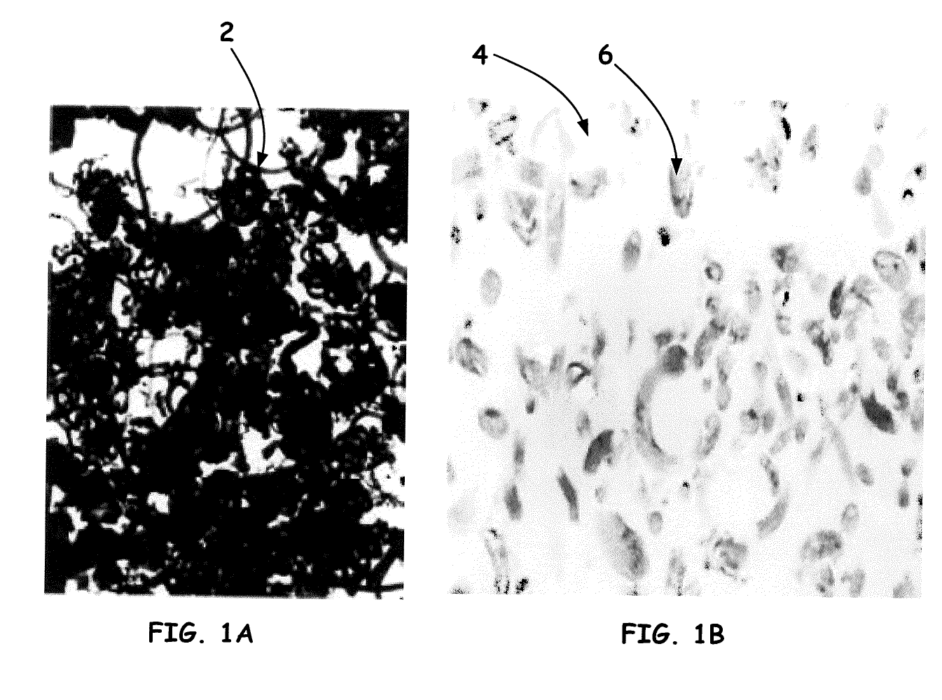

Turning now the drawings, FIG. 1A and FIG. 1B show the results of the present embodiments in converting nano-fillers into liquid nano-agents and then mixing the liquid nano-agent with polymeric materials via a facile method to produce property enhanced nano-modified polymer nanocomposites. Example polymeric materials include epoxy resins, epoxy vinyl esters, polyurethanes, or at least one high performance polymer material selected from: polyimide (PI), Poly(aryletherketone)s (PAEKs), Poly (p-phneylene sulfide) (PPS), polysulfone (PSU), and a Polycarbonate, poly(phenyleneethynylenes) (PPEs), polythiophene, polyanaline, and polypyrroles.

Turning back to the figures, FIG. 1A shows an image of raw nano-fillers 2 in an undesirable entangled and agglomerated configuration while FIG. 1B shows an image of the Liquid nano-agent (LNA) 4 having uniform dispersed nano-fillers 6 via the novel method herein, which is enabled by adding the raw nano-fillers into the solvent under sonication.

The beneficial and non-obvious result is a consistent quality so as to overcome state of the art problems, as discussed above. Thus, the novel embodiments herein result in nanocomposite materials and processing nanotechnologies to enable a broad set of related capabilities targeted for broad applications, as also discussed above.

The present invention will be more fully understood by reference to the following examples, which are intended to be illustrative of the present invention, but not limiting thereof. Accordingly, the techniques disclosed in the following are representative of the methods in the practice of the present invention.

### EXAMPLE

The liquid nano-agent (LNA), as disclosed herein, can be fabricated through cutting the nano-fillers (such as carbon nanofibers, carbon nanotubes, graphene nanoparticles, and fullerenes, etc.) by digital sonifier under a solvent, such as, Dimethyl sulfoxide (DMSO), o-dichlorobenzene (ODCB), tetrahydrofuran (THF), N,N-dimethylformamide (DMF), chloroform, N-methylpyrrolidone (NMP), acetone, methyl ethyl ketone (MEK), dichloromethane, toluene, N,N-dimethylacetamide (DMAc), Dichloromethane (DCM), but more often butyl glycidyl ether (BGE). The formation process of the sonication treated nano-fillers will be then formed as a solution of nano-fillers and the solvent.

For example, commercial pristine carbon nanofibers (P-CNFs) and oxidized carbon nanofibers (O-CNFs) can be used for making the LNA: The P-CNFs and O-CNFs are placed separately into glass beakers containing about 200 grams of the BGE solvent. The solutions are sonication mixed at 20% power for 3 hours using an ultra-sonicator, such as, but not limited to, a Heat Systems W385 ultra-sonicator. Sonication mixing, as discussed above, helps to break up the CNF aggregations and also breaks the CNF lengths to smaller and easier to disperse lengths, which is a desired result. This degree of sonication often achieves lengths in the range from 1 to 5 μm.

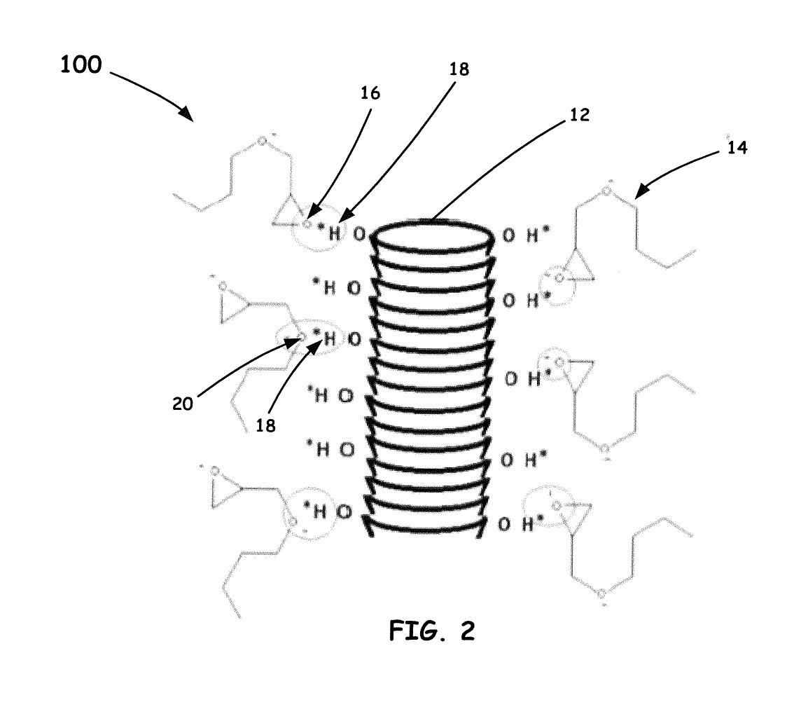

For this non-limiting example, the solutions are allowed to settle for not less than 3 days. At this time a visible separation of CNFs and clear BGE developed. CNFs being of higher density settle to the bottom of the beaker. The excess BGE was syringe drawn out and placed into a separate beaker for later use. After manual extraction of excess BGE is complete, the solution is placed in a vacuum oven at 100° C. and 26″-Hg to extract the excessive loose BGE molecules from the BGE/CNF black tar. This operation is carried out until the ratio of BGE/CNFs is approximately 4:1 by weight. This temperature is closer to the boiling point of BGE at 1 atmosphere (101 KPa). However, it is to be appreciated that in vacuum, 100° C. is easier to manage the rate of extraction of BGE and avoid extracting too much too fast. FIG. 2 shows a mixing, as generally referenced by the numeral 100, wherein cup stacked CNFs are shown along with B GE (butyl glycidyl ether solvent) surface molecules (non-covalent bond: one of the physical bonds: hydrogen bond). In particular, the cup stacked CNFs 12 interact with the BGE surface molecules via hydrogen bonding interactions, i.e., hydroxyl groups on the surface of the CNF hydrogen bound two functional groups of the BGE 14. In detail in looking at FIG. 2, hydrogen bonding interaction can be observed between the epoxide oxygen 16 of the BGE 14 and the hydrogen 18 of the hydroxyl on the CNF 12. Additionally, hydrogen bonding interaction can be observed between the ether oxygen 20 of the BGE and the hydrogen 18 of the hydroxyl group on the CNF 12.

It is to be understood that features described with regard to the various embodiments herein may be mixed and matched in any combination without departing from the spirit and scope of the invention. Although different selected embodiments have been illustrated and described in detail, it is to be appreciated that they are exemplary, and that a variety of substitutions and alterations are possible without departing from the spirit and scope of the present invention.

1. A method for uniformly dispersing a nanomaterial within a polymer, the method comprising:
adding a nano-filler to a solvent;
subjecting the nano-filler in the presence of the solvent to sonication so as to provide for a liquid nano-agent; and
adding the liquid nano-agent with a polymeric material to produce a nano-modified polymer nanocomposite or a fiber reinforced composite.

2. The method of claim 1, wherein the solvent is selected from at least one of the following: Dimethyl sulfoxide (DMSO), o-dichlorobenzene (ODCB), tetrahydrofuran (THF), N,N-dimethylformamide (DMF), methanol, N-methylpyrrolidone (NMP), acetone, methyl ethyl ketone (MEK), dichloromethane, toluene, N,N-dimethylacetamide (DMAc), Dichloromethane (DCM) and butyl glycidyl ether (BGE).

3. The method of claim 1, wherein the polymeric material is at least one polymer selected from: polyimide (PI), Poly(aryletherketone)s (PAEKs), Poly (p-phneylene sulfide) (PPS), polysulfone (PSU), and a Polycarbonate, poly(phenyleneethynylenes) (PPEs), polythiophene, polyanaline, and polypyrroles.

4. The method of claim 1, wherein the polymeric material is a resin.

5. The method of claim 1 wherein the nano-filler is at least one of from the group consisting of: carbon nanotubes, carbon nanofibers, graphene nanoparticles, a fibrillar nanoparticle, and fullerenes.

6. The method of claim 1 wherein sonication provides nano-filler lengths in the range from 1 μm to 5 μm.

7. The method of claim 1, further comprising extracting an excess of the solvent so as to enable later use.

8. The method of claim 7, further comprising placing the excess solvent in a vacuum oven at up to about 100° C. to extract the excessive loose solvent molecules from a solvent/carbon nano-filler black tar.

9. The method of claim 8, wherein the step of placing the excess solvent in a vacuum oven at up to about 100° C. is carried out until the ratio of the solvent/carbon nano-filler is approximately 4:1 by weight.

10. The method of claim 1, wherein the nano-fillers are modified by at least method selected from: oxidizing and functionalizing.

11. A polymer-carbon matrix, comprising:
a nano-solution comprising modified nano-fillers and a solvent undergoing sonication to provide for a liquid nano-agent, wherein the nano-filler is at least one nano-filler selected from: carbon nanotubes, carbon nanofibers, graphene nanoparticles, fibrillar nanoparticles, and fullerenes; and
a polymeric material compatible with the solvent and configured to receive the liquid nano-agent.

12. The polymer-carbon matrix of claim 11, wherein the solvent is selected from at least one of the following: Dimethyl sulfoxide (DMSO), o-dichlorobenzene (ODCB), tetrahydrofuran (THF), N,N-dimethylformamide (DMF), methanol, N-methylpyrrolidone (NMP), acetone, methyl ethyl ketone (MEK), dichloromethane, toluene, N,N-dimethylacetamide (DMAc), Dichloromethane (DCM) and butyl glycidyl ether (BOB).

13. The polymer-carbon matrix of claim 11, wherein the polymeric material is at least one polymer selected from: polyimide (PI), Poly(aryletherketone)s (PAEKs), Poly(p-phneylene sulfide) (PPS), polysulfone (PSU), and a Polycarbonate, poly(phenyleneethynylenes) (PPEs), polythiophene, polyanaline, and polypyrroles.

14. The polymer-carbon matrix of claim 11, wherein the polymeric material is a resin.

15. The polymer-carbon matrix of claim 11, wherein the nano-16. fillers after sonication have lengths in the range from 1 μm to 5 μm.

16. The polymer-carbon matrix of claim 11, wherein the nano-filler is a dry carbon particle.
